(19) United States
(12) Patent Application Publication
(10) Pub. No.: US 2005/0138388 A1
(43) Pub. Date: Jun. 23, 2005

(54) System and method for managing cross-certificates copyright notice

(76) Inventors: Robert Paganetti, Scituate, MA (US); Alan Eldridge, Hollis, NH (US); Charles Kaufman, Sammamish, WA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/741,315

(22) Filed: Dec. 19, 2003

(51) Int. Cl. H04K 1/00

(52) U.S. Cl. 713/185

(57) ABSTRACT

The invention provides a method for managing cryptographically generated data tokens, the method comprising: decoding a data file to retrieve a first cryptographically generated data token, identifying a second cryptographically generated data token associated with the first data token, and updating the second data token according to a security preference related to a characteristic of the first or the second data token.

### COPYRIGHT NOTICE

A portion of the disclosure of this patent document contains material which is subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND OF THE INVENTION

The invention disclosed herein relates generally to cryptographic communications and more particularly to managing cryptographically generated data tokens such as cross-certificates associated with e-mail messages.

E-mail messages, file transfers, packet traffic, and other types of electronic information are frequently communicated between networked systems, and electronic data transfer is an inherent aspect of networked environments. E-mail particularly has become an extremely popular means of communication and people send millions of messages over the Internet every day.

The first e-mails consisted of text messages, such as ASCII text messages. As mail applications became more complex to meet the rising demands of increasingly sophisticated users, however, e-mail transport began to support a variety of different information formats and file types. Today, for example, users can send e-mail messages containing text, music, graphics, videos, software applications, data files, and other types of multi-media information.

One method used to support such diverse content types in e-mail messages is the Multi-Purpose Internet Mail Extensions (“MIME”) protocol. Mime is an extension of the Simple Mail Transport Protocol (“SMTP”) which was the foundation of many of the original ASCII e-mail messaging systems. MIME is described in further detail in Internet Request for Comments (“RFC”) 1521 and 1522, which amend the original mail protocol specification, RFC 821 (the Simple Mail Transport Protocol) and the ASCII messaging header, RFC 822, each of which is hereby incorporated herein by reference in their entirety. MIME enables mail application servers and clients to decode e-mail messages and other file types to select the appropriate software application or player for content file types embedded in a given e-mail. For example, a user might attach a graphics file to an e-mail. The user's MIME-enabled mail server recognizes the attachment and inserts a MIME header at the beginning of the communication transmitting the user's e-mail. The MIME header identifies a MIME-type, for example the type of graphics file, as well as provides additional information, which enables other mail clients to select the appropriate application to open the type of file contained in the e-mail.

While e-mail has simplified and expanded communications between networked users, communication security has also become an important concern. As more and more users become familiar with e-mail and use e-mail to send everyday communications, it becomes increasingly evident that many users, especially business and government users, are also using e-mail to transmit sensitive information. For these users, they often need to be able to rely on or trust that a particular message was really communicated by a particular sender and is not a forgery.

Unfortunately, one drawback associated with electronic communications, and e-mail systems generally, is that electronic communications are extremely susceptible to interception and forgery unless proper security precautions are enacted.

One method used to secure electronic communications, such as e-mails, is the Secure Multi-Purpose Internet Mail Extensions (“S/MIME”) protocol. The S/MIME protocol is further described in RFC 2311, 2312, 2632, 2633, and 2634, each of which is hereby incorporated herein by reference in its entirety. S/MIME is a secure method of sending e-mail that uses the Rivest-Shamir-Adleman (“RSA”) encryption system, though those skilled in the art will recognize that any encryption scheme supporting similar functionality could be employed to secure electronic communications and data transfers. For example, PGP/MIME is another secure mail protocol proposed as an alternative to S/MIME which could also be used to support the functionality of the systems further described herein. Using RSA encryption techniques, S/MIME embeds digital tokens, such as cryptographic digital signatures or certificates, in e-mails and these digital tokens can be used to authenticate the identity of a sender.

RSA is a type of public key infrastructure (“PKI”) encryption scheme which uses two types of keys, public keys and private keys, to secure electronic communications. Thus, if a user wants to ensure against forgery by digitally signing a message indicating that they are the actual sender, the user “signs” the message with the user's private key, creating a cryptographic signature, and then embeds a digital certificate that consists of the user's corresponding public key in the message itself. The recipient can then validate the signature and look at the digital certificate to validate trust of the sender.

The digital certificate serves as a verifiable credential that can be decoded to validate the user's identity. A digital certificate generally contains various information such as the certificate holder's name or serial number, the certificate's expiration date, the certificate holder's public key, the digital signature of the certificate by the issuing authority (“CA”), the identity of the issuing authority, and other similar information known in the art. Digital certificates are generally issued or created by a certificate-issuing authority that creates the certificate using the user's public key. In some instances, the CA is also responsible for issuing the user their public and private keys. Thus, recipients are able to verify the digital certificate serving as the user's credentials by using the user's public key to decrypt the digital signature.

Some mail systems and applications allow users to manage digital certificates associated with other users. For example, when an e-mail with a cryptographic signature is first received from a sender, some mail applications allow the recipient to generate a digital cross-certificate stored in a directory accessible to the user indicating that the mail system should always trust signed e-mails being sent from that particular sender with that particular digital certificate. For example, a recipient might take a sender's certificate and cross it with the recipient's private key to generate a unique cross-certificate stored in the directory that the recipient can use to authenticate future signed mail from the sender. Thus, a recipient might look at the certificate chain contained in the certificate of the sender's e-mail to determine whether they trust any of the certificates in this chain. For example, in a corporate environment, while a recipient might not be personally familiar with the sender, the recipient might trust the sender's CA, for example, the parent company or division that generated the sender's digital certificate. In such a scenario, the sender's certificate is called a leaf certificate and the recipient is examining the other certificates in the certificate tree or chain of the leaf certificate for trust. Assuming a recipient decides to trust the sender's certificate, the recipient then generates a cross-certificate associated with the sender's certificate.

One problem associated with cross-certificates is that they carry an expiration date for security purposes. Many systems, for example, generate cross-certificates that are valid for one year. Thus, when signed mail is received from a sender for whom the corresponding cross-certificate has expired, the mail system does not trust that mail and the mail may be discarded or otherwise treated as suspect.

There is thus a need for systems and methods which allows users to manage cross-certificates more efficiently. There is also a need for systems and methods which allow users to manage expiring cross-certificates.

### SUMMARY OF THE INVENTION

The present invention addresses, among other things, the problems discussed above with managing cryptographically generated data tokens used in electronic communications. The present invention also addresses the problems discussed above with managing cross-certificates used in electronic mail systems.

In accordance with some aspects of the present invention, computerized methods are provided for managing cryptographically generated data tokens, the methods comprising: decoding a data file to retrieve a first cryptographically generated data token; identifying a second cryptographically generated data token associated with the first data token; and updating the second data token according to a security preference related to a characteristic of the first or the second data token.

In some embodiments, the data file comprises an electronic communication, for example, an e-mail message such as an S/MIME encoded e-mail message. In some embodiments, the first data token comprises a digital certificate and the second cryptographically generated data token comprises a cross-certificate.

In some embodiments, updating the second data token according to a security preference comprises updating the second data token according to a time period related to an expiration date, for example, the expiration date of the first or second data token. In some embodiments, updating the second data token comprises changing the expiration date of the second data token as directed by a user or automatically according to a security profile associated with the second data token. In some embodiments, the system updates the second data token according to a security preference related to a characteristic comprises updating according to a security preference related to a characteristic from the group consisting of a user identity, a user serial number, an expiration date, an issuance date, and a certificate authority identity.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a flow chart of a method of managing cryptographically generated data tokens according to an embodiment of the present invention; and

FIG. 2 is a block diagram of an exemplary electronic communication system for managing cryptographically generated data tokens according to an embodiment of the present invention;

FIG. 3 is a flow chart of a method of updating cryptographically generated data tokens associated with an electronic communication according to an embodiment of the present invention; and

FIG. 4 is a flow chart of a method updating cryptographically generated data tokens contained in a data store according to an embodiment of the present invention.

### DETAILED DESCRIPTION

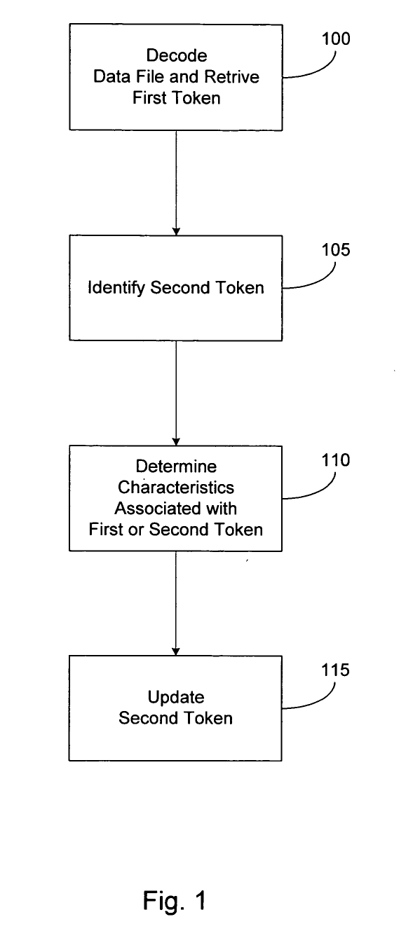

Preferred embodiments of the invention are now described with reference to the drawings. As described further below, systems and methods are presented for managing cryptographically generated data tokens such as cross-certificates associated with electronic communication systems. FIG. 1 presents a flow chart of a method of managing cryptographically generated data tokens according to an embodiment of the present invention. A data file is decoded and a first cryptographically generated data token is retrieved, step 100. For example, in some embodiments, the data file is an e-mail message, and the first cryptographically generated data token is a digital certificate generated as part of a PKI system or other type of encryption scheme. In other embodiments, the data file represents other types of data files such as digital packets, software applications, electronic documents, multi-media files, electronic communications, and other types of data files. In some embodiments, the digital file is an electronic file received by an operating system (as opposed to a mail system) and processed accordingly and as further described herein to authenticate the identity of the sender.

A second cryptographically generated data token related to the first data token is identified, step 105. For example, in some embodiments, a cross-certificate related to a digital certificate contained in an e-mail message is identified.

The first data token and/or the second token is analyzed or otherwise evaluated to determine characteristics associated with the first or second data token, step 110. For example, in some embodiments a digital certificate is processed to determine a characteristic associated with the digital certificate such as the certificate holder's name or serial number, the certificate's expiration date, the certificate holder's public key, the digital signature of the related certificate-issuing authority, and other similar information known to those of skill in the art. In other embodiments, a cross-certificate is processed to determine characteristics associated with the cross-certificate such as the cross-certificate holder's name or serial number, the cross-certificate'expiration date, the cross-certificate holder's public key, the digital signature of any related certificate-issuing authority, and other similar information known to those of skill in the art. For example, a cross-certificate related to a digital certificate contained in an e-mail is evaluated to determine whether the cross certificate has expired or is about to expire.

The second data token is updated according to a security preference related to a characteristic of the first or the second data token, step 115. For example, a cross-certificate is updated and renewed if the cross-certificate's expiration date has occurred or is scheduled to occur within a specified time period. In some embodiments, the time period or the decision to renew a cross-certificate may be specified by a user via manual input. In other embodiments, the time period or decision to renew a cross-certificate may be calculated by the system automatically using a data structure or other security profile containing security preferences associated with a cross-certificate. For example, a system administrator may create a security profile associated with a cross-certificate that instructs the system to perform various actions on the cross-certificate in various instances, such as when the cross-certificate is about to expire, etc.

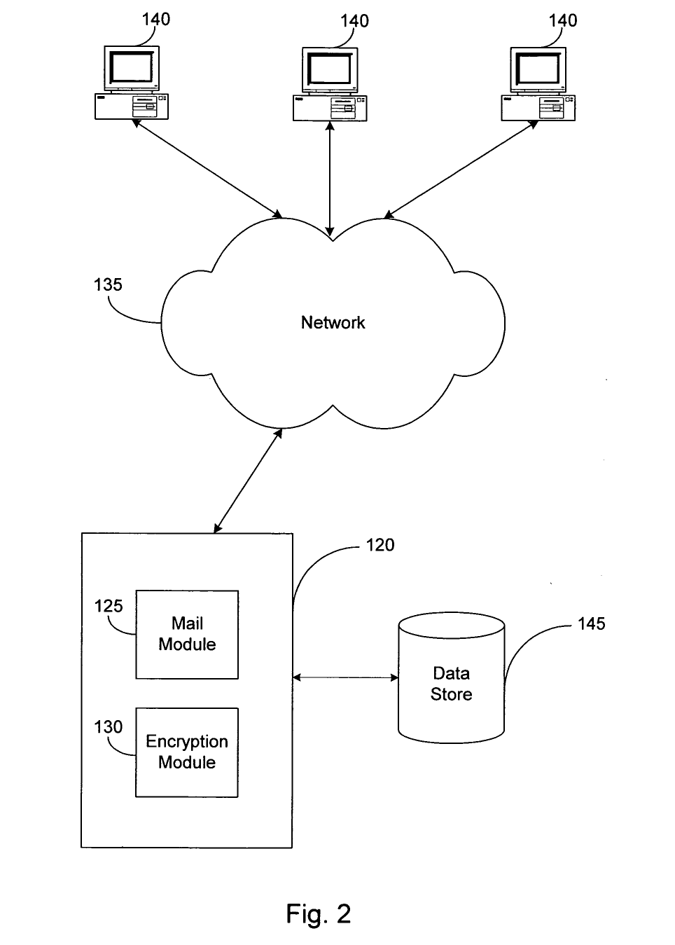

FIG. 2 presents a block diagram of an exemplary electronic communication system for managing cryptographically generated data tokens according to an embodiment of the present invention. As shown, the system includes a mail server 120 executing a mail module 125 and an encryption module 130, a network 135, one or more client computers 140, and a data store 145.

The mail server 120 is generally a server or other general purpose computer executing a mail module 125 and an encryption module 130. The mail server 120 is connected to a network 135 such as a local area network (“LAN”), a wide area network (“WAN”), a wireless network, the Internet, an Intranet, or other type of network known in the art. One or more client computers 140 communicate with the mail server 120 via the network 135. In some embodiments, client computers 140 send e-mail messages to the mail server 120 via the network 135.

The mail module 125 generally processes incoming electronic communications, such as e-mail messages. The encryption module 130 generally assists the mail module 125 to decode mail messages that include encrypted digital signatures. For example, in some embodiments the mail module 125 decodes S/MIME encoded mail messages to extract encrypted digital signatures contained in the messages and locate related cross-certificates stored in a directory or a data store 145 in communication with the mail server 120. In some embodiments, the encryption module 130 also includes programming directed to managing cross-certificates that have expired or that are about to expire within a specified time period.

In some embodiments, the mail module 125 and the encryption module 130 are parts of the same program, for example a mail application such as Lotus Notes or Microsoft Outlook. In other embodiments, the mail module 125 and the encryption module 130 are parts of different programs, for example the mail module 125 might be a part of Microsoft Outlook and the encryption module 130 a part of a second program by a different manufacturer that merely interfaces with the mail program 125. Those skilled in the art will recognize that the mail module 125 represents an exemplary module and that the invention should not be construed as being limited in functionality or applicability to only mail-related applications since the systems and methods disclosed herein could equally be implemented by an operating system, a chat program, an instant messaging program, banking electronic funds transfer systems, or other types of program directed to processing electronic communications and data.

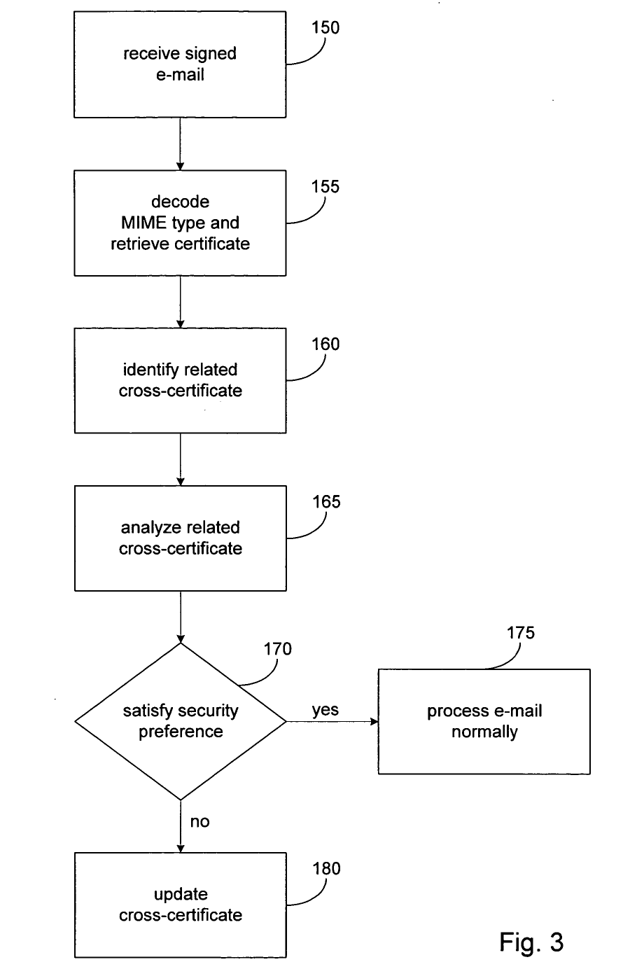

FIG. 3 presents a flow chart of a method of updating cryptographically generated certificates associated with an e-mail according to an embodiment of the invention. The system receives a signed e-mail message containing a digital certificate, step 150.

The system processes header information associated with the e-mail to decode the MIME type and retrieves the digital certificate, step 155. For example, in some embodiments, a mail system decodes the header information and determines that the message is signed and encoded using the S/MIME protocol. In other embodiments, the system decodes the header information and determines that the message is signed and encoded using PGP/MIME, open/MIME, or another MIME encryption scheme known in the art.

The system identifies a corresponding cross-certificate related to the digital certificate, step 160. For example, in some embodiments, the mail module and/or the encryption module queries a data store or other directory containing previously generated cross-certificates to identify the related cross-certificate.

The system analyzes and processes the related cross-certificate, step 165, to determine characteristics associated with the cross-certificate such as the cross-certificate holder's name or serial number, the cross-certificate's expiration date, the cross-certificate holder's public key, the digital signature of any related certificate-issuing authority, and other similar information known in the art. In some embodiments, the system alternatively or additionally analyzes and processes the digitally encrypted certificate to determine a characteristics associated with the digital certificate such as the certificate holder's name or serial number, the certificate's expiration date, the certificate holder's public key, the digital signature of the related certificate-issuing authority, and other similar information known in the art.

One or more characteristics (of either the cross-certificate or of the digital certificate) is evaluated to determine whether the characteristic satisfies a security preference, step 170. If the security preference is satisfied, the system processes the e-mail normally, step 175. If, however, the characteristic does not satisfy the security preference, then the system updates the cross-certificate as further described herein, step 180.

For example, in some embodiments, the mail module and/or the encryption module evaluates the expiration date of the cross-certificate to determine whether the cross-certificate expires within a specified time period. Thus, if a signed e-mail is received and its corresponding cross-certificate is set to expire within the time period, the system offers the user an opportunity to update and renew the cross-certificate before it expires. In some embodiments, the system displays an alert or other notification and prompts the user regarding whether or not to renew the cross-certificate. In other embodiments, the system updates the cross-certificate automatically using a data structure or other security profile containing security preferences associated with a cross-certificate. For example, a user such as a system administrator may associate a security policy with a particular cross-certificate indicating that the certificate should be renewed automatically and its expiration date changed by the system whenever mail is received within a specified time period, such as one month, of the certificate's current expiration date. Alternatively, in some embodiments, the system may contain preprogrammed defaults indicating security preferences associated with renewing certificates according to various characteristics. In some embodiments, these data structures and security preferences are stored in a data store communicatively coupled with the mail server.

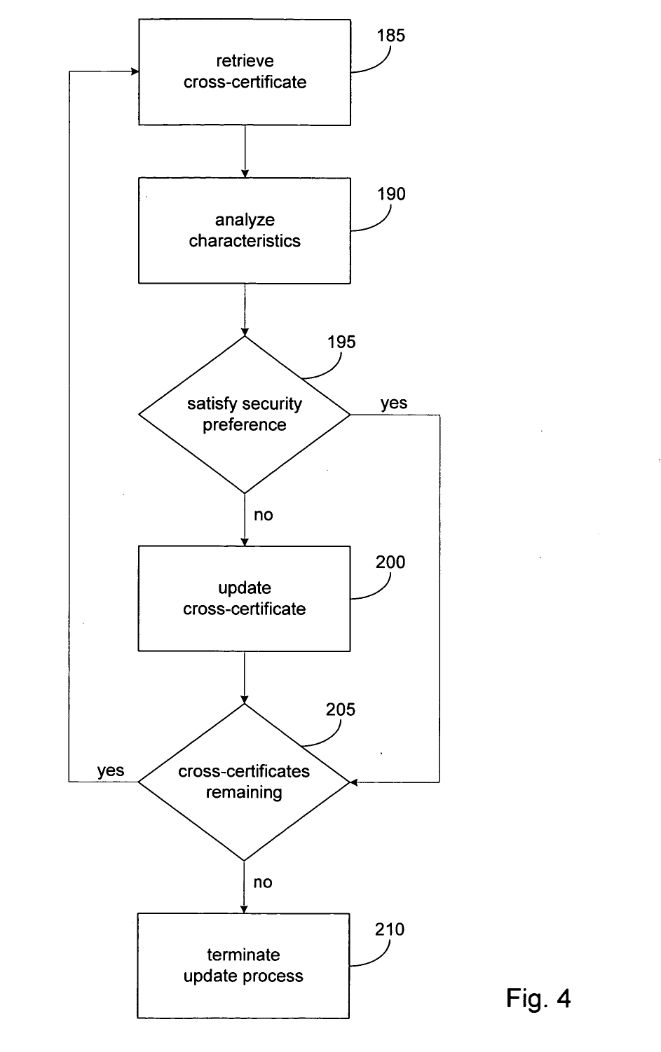

FIG. 4 presents a flow chart of a method of updating cryptographically generated data tokens contained in a data store according to an embodiment of the invention. In some embodiments, the system also manages cross-certificates proactively and does not wait until mail messages are received to update cross-certificates. The system retrieves a cross-certificate from the directory or data store where cross-certificates are stored, step 185. For example, in some embodiments, the encryption module or other module retrieves cross-certificates from the data store. In some embodiments, the encryption module or other module queries the data store and retrieves only cross-certificates satisfying a certain criteria such as those associated with a particular company or individual, created by a certain date, etc.

The cross-certificate's characteristics are processed and evaluated, step 190. For example, the system analyzes the cross-certificate to determine one or more of the group consisting of the cross-certificate holder's name or serial number, the cross-certificate's expiration date, the cross-certificate holder's public key, the digital signature of any related certificate-issuing authority, and other similar information known in the art.

The system determines whether the characteristic(s) of the cross-certificate satisfies a security preference, step 195. For example, in some embodiments, the system checks to determine whether the cross-certificate is scheduled to expire within a specified time period or whether the cross-certificate has already expired. If the cross-certificate satisfies the security preference, the system checks to see if the data store contains additional cross-certificates to be analyzed, step 205, and control either returns to step 185 to retrieve the next cross-certificate or else the update process terminates, step 210, if no additional cross-certificates remain.

If the cross-certificate does not satisfy the security preference in step 195, however, the system updates the cross-certificate, step 200, as previously described herein. For example, the system may prompt the user for input regarding whether they wish to renew or otherwise update the certificate. Alternatively, the system may automatically update the certificate according to a security profile or other means associated with the cross-certificate as previously described herein.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A method for managing cryptographically generated data tokens, the method comprising:
decoding a data file to retrieve a first cryptographically generated data token;
identifying a second cryptographically generated data token associated with the first data token; and
updating the second data token according to a security preference related to a characteristic of the first or the second data token.

2. The method of claim 1, wherein decoding a data file comprises decoding an electronic communication.

3. The method of claim 2, wherein decoding an electronic communication comprises decoding an e-mail message.

4. The method of claim 3, wherein decoding an e-mail message comprises decoding an S/MIME encoded e-mail message.

5. The method of claim 1, wherein decoding a data file to retrieve a first data token comprises decoding a data file to retrieve a digital certificate.

6. The method of claim 5, wherein identifying a second cryptographically generated date token comprises identifying a cross-certificate.

7. The method of claim 1, wherein updating the second data token according to a security preference comprises updating the second data token according to a time period related to an expiration date.

8. The method of claim 7, wherein updating the second data token according to a time period relating to an expiration date comprises updating the second data token according to a time period related to the expiration date of the first or second data token.

9. The method of claim 8, wherein updating the second data token comprises changing the expiration date of the second data token.

10. The method of claim 9, comprising changing the expiration date as directed by a user.

11. The method of claim 9, comprising changing the expiration date automatically according to a security profile associated with the second data token.

12. The method of claim 1, wherein updating according to a security preference related to a characteristic comprises updating according to a security preference related to a characteristic from the group consisting of a user identity, a user serial number, an expiration date, an issuance date, and a certificate authority identity.

13. A system for managing cryptographically generated data tokens, the system comprising:
a data file containing a first cryptographically generated data token;
a data store; and
a processor communicatively coupled to the data store;
wherein the processor is programmed to:
decode the data file to retrieve the first cryptographically generated data token;
identify, in the data store, a second cryptographically generated data token associated with the first data token; and
update the second data token according to a security preference related to a characteristic of the first or second data token.

14. The system of claim 13, wherein the data file comprises an electronic communication.

15. The system of claim 14, wherein the electronic communication comprises an e-mail message.

16. The system of claim 15, wherein the e-mail message comprises an S/MIME encoded e-mail message.

17. The system of claim 13, wherein the first data token comprises a digital certificate.

18. The system of claim 17, wherein the second cryptographically generated date token comprises a cross-certificate.

19. The system of claim 13, wherein the security preference comprises a time period related to an expiration date.

20. The system of claim 19, wherein the time period relating to an expiration date comprises a time period related to the expiration date of the first or second data token.

21. The system of claim 20, comprising changing the expiration date of the second data token.

22. The system of claim 21, comprising changing the expiration date as directed by a user.

23. The system of claim 21, comprising changing the expiration date automatically according to a security profile associated with the second data token.

24. The system of claim 13, wherein the security preference is related to a characteristic from the group consisting of a user identity, a user serial number, an expiration date, an issuance date, and a certificate authority identity.

25. A computer usable medium or media storing program code which, when executed on a computerized device, causes the computerized device to execute a method for managing cryptographically generated data tokens, the method comprising:
decoding a data file to retrieve a first cryptographically generated data token;
identifying a second cryptographically generated data token associated with the first data token; and
updating the second data token according to a security preference related to a characteristic of the first or the second data token.

26. The computer usable medium or media of claim 25, wherein decoding a data file comprises decoding an electronic communication.

27. The computer usable medium or media of claim 26, wherein decoding an electronic communication comprises decoding an e-mail message.

28. The computer usable medium or media of claim 27, wherein decoding an e-mail message comprises decoding an S/MIME encoded e-mail message.

29. The computer usable medium or media of claim 25, wherein decoding a data file to retrieve a first data token comprises decoding a data file to retrieve a digital certificate.

30. The computer usable medium or media of claim 29, wherein identifying a second cryptographically generated date token comprises identifying a cross-certificate.

31. The computer usable medium or media of claim 25, wherein updating the second data token according to a security preference comprises updating the second data token according to a time period related to an expiration date.

32. The computer usable medium or media of claim 31, wherein updating the second data token according to a time period relating to an expiration date comprises updating the second data token according to a time period related to the expiration date of the first or second data token.

33. The computer usable medium or media of claim 32, wherein updating the second data token comprises changing the expiration date of the second data token.

34. The computer usable medium or media of claim 33, comprising changing the expiration date as directed by a user.

35. The computer usable medium or media of claim 33, comprising changing the expiration date automatically according to a security profile associated with the second data token.

36. The computer usable medium or media of claim 25, wherein updating according to a security preference related to a characteristic comprises updating according to a security preference related to a characteristic from the group consisting of a user identity, a user serial number, an expiration date, an issuance date, and a certificate authority identity.
